(19) United States
(12) Patent Application Publication
(10) Pub. No.: US 2018/0245974 A1
(43) Pub. Date: Aug. 30, 2018

(54) METHOD FOR MEASURING LIGHT FOR LED REPLACEMENT

(71) Applicant: Truly Green Solutions, LLC, Chatsworth, CA (US)

(72) Inventor: Blake Thomas Murphy, Chatsworth, CA (US)

(21) Appl. No.: 15/880,456

(22) Filed: Jan. 25, 2018

Related U.S. Application Data
(60) Provisional application No. 62/450,980, filed on Jan. 26, 2017.

(51) Int. Cl. G01J 1/42; F21K 9/20; G01J 3/50

(52) U.S. Cl. CPC G01J 1/42; F21Y 2115/10; G01J 3/505; F21K 9/20

(57) ABSTRACT

Methods for replacing conventional light fixtures with solid state light fixtures are disclosed that can comprise selecting a replacement area comprising a plurality of conventional lamps. A sample of the plurality of conventional lamps in the replacement area is selected. The emission characteristics for each of the sample plurality of conventional lamps is measured. The conventional lamp emission characteristics are matched to emission characteristics of replacement LED lamps. All of the conventional lamps within said light replacement area are replaced with the replacement LED lamps. The emission characteristics of the LED replacement lamps at each of said locations of the sample plurality of conventional lamps are measured. The sample conventional lamp emission characteristics are compared to the LED replacement lamp characteristics to confirm that they are the same or are within an acceptable deviation.

This application claims the benefit of U.S. Provisional Patent Application Ser. No. 62/450,980, filed on Jan. 26, 2017.

### BACKGROUND OF THE INVENTION

### Field of the Invention

The present invention relates to light emitting diode (LED) lighting, and a method for measuring light output from conventional light sources so that a matching LED replacement light can be provided.

### Description of the Related Art

LEDs have become a popular light source for most lighting applications because of their reliability and efficiency. LED technology has been readily adapted across almost every industry and is predicted to have close to 100% saturation by 2035, including “niche” lighting markets. The slowest to adapt to LED and the energy/cost savings involved have been the high profile and specialty venues where lighting is a critical part of the customer experience, history, or sales methodology of the end use application.

Nearly 13% of the area and roadway lighting in the United States is now LED lighting, and many communities that have not transitioned to energy efficient LED lighting have plans to do so. End users across all industries are learning new terminology and evaluation methods that have fundamentally changed as LED lighting has become the generally accepted lighting standard. Professionals responsible for lighting replacement in certain applications, such as exhibition lighting, are confronted with big and expensive decisions. These are complicated by the fact that LED technology offers the possibility of a better (and/or different and/or worse) viewing experience than we are accustomed to. It also offers the likelihood of drastically reduced energy consumption (for light and building cooling), maintenance costs related to changing light bulbs, and waste in the form of spent bulbs and packaging.

A proliferation of poor LED installations may change the look, dynamic, or aesthetic of various venues ranging from stadiums, concert halls, theatres and other entertainment venues, art galleries, high end residential, historic buildings, certain types of retail including (art, jewelry, antiques, etc.) Most LEDs are made in a relatively limited range of colors considering the available spectrum of available colors and the relative ease and cost effectiveness of rendering almost any color temperature with a high CRI.

Recent press has highlighted the many concerns that have arisen with making the switch to a much “whiter” color temperature of 4000K. A Washington Post article states “in many places, including New York City and Seattle, residents complained that the bright white light was harsh, even lurid. People described them as invasive, cold and unflattering.” The American Medical Association (AMA) issued a recent report that has sent shockwaves through the residential street lighting community. The article states, “High-intensity LED lighting designs emit a large amount of blue light that appears white to the naked eye and create worse nighttime glare than conventional lighting.”

Discomfort and disability from intense, blue-rich LED lighting can decrease visual acuity and safety, resulting in concerns and creating a road hazard.” Emboldened by these recent reports, well-meaning residents nationwide are petitioning their communities to “take another look at LED lighting”, or even replace existing LED fixtures and lamps with “amber colored” lamps.

### SUMMARY OF THE INVENTION

The present invention is generally directed to different methods for accurately and efficiently matching LED lighting to conventional non-LED light sources during replacement of the non-LED light sources. The present invention is particularly adapted to a method for matching LED lighting with existing lighting characteristics so that the negative experiences with LED replacement lighting described above, can be avoided. This will improve acceptance of LED lighting in many applications, allowing the users to enjoy the many benefits of LED lighting.

One of the many embodiments of methods for replacing conventional light fixtures with solid state light fixtures according to the present invention comprises selecting a replacement area comprising a plurality of conventional lamps. A sample of the plurality of conventional lamps in the replacement area is selected. The emission characteristics for each of the sample plurality of conventional lamps is measured. The conventional lamp emission characteristics are matched to emission characteristics of replacement LED lamps. All of the conventional lamps within said light replacement area are replaced with the replacement LED lamps. The emission characteristics of the LED replacement lamps at each of said locations of the sample plurality of conventional lamps are measured. The sample conventional lamp emission characteristics are compared to the LED replacement lamp characteristics to confirm that they are the same or are within an acceptable deviation.

These and other features and advantages of the invention will be apparent to those skilled in the art from the following detailed description, taken together with the accompanying drawings.

### BRIEF DESCRIPTION OF THE DRAWINGS

FIG. 1 is a flow diagram for one embodiment of a method according to the present invention;

FIG. 2 is a flow diagram for another embodiment of a method according to the present invention;

FIG. 3 is a perspective view of one embodiment of a portable spectrometer that can be used in the methods according to the present invention;

FIG. 4 is a diagram showing one embodiment of indoor sample test set used in methods according to the present invention;

FIG. 5 is a diagram showing one embodiment of outdoor sample test set used in methods according to the present invention;

FIG. 6 is a diagram showing one embodiment of outdoor testing pattern that can be used in methods according to the present invention;

FIG. 7 is a diagram showing one embodiment of indoor testing pattern that can be used in methods according to the present invention;

FIG. 8 is a schematic side view of one embodiment of outdoor testing pattern in methods according to the present invention;

FIG. 9a is a schematic side view of one embodiment of indoor testing position pattern used in methods according to the present invention; and

FIG. 9b is a schematic side view of another embodiment of indoor testing position pattern used in methods according to the present invention.

### DETAILED DESCRIPTION OF THE INVENTION

The present invention provides for a reliable and efficient method for measuring light produced at indoor or outdoor locations by conventional light sources, and then matching color and light spectrum blend with replacement LED lighting. Different locations can require different colors or color temperatures to match existing lighting conditions, and the present invention provides a method to match existing lighting conditions with new LED lighting. The present invention can be used in replacing many different conventional light sources, including but not limited to, incandescent, fluorescent, CFL, metal halide, quartz, low pressure sodium, high pressure sodium, and others.

The methods according to the present invention can maximize lighting performance and efficiency while virtually eliminating the extreme glare of unpleasant blue or UV light. The color matching procedures disclosed herein can be used in many different applications where conventional lighting is being replaced by LED lighting, but are particularly applicable to high-profile or sensitive LED retrofitting or re-lamping projects where precise correlated color temperature (CCT) equivalent LED technology is required.

One benefit of the present invention to prevent or reduce public dissatisfaction with lighting replacement projects. For example, LED municipal street lighting replacement can often result in untended adverse reactions from community members if the color of the replacement lighting is significantly different than the conventional source. This problem has prevented certain venues and lighting applications from replacing legacy lighting technology with LED lighting due to concerns about a shift in color temperature, CRI, or R9 values after switching to off-the-shelf or custom LED products. The actual products used in the methods according to the present invention can vary by application, but the color matching process is similar for all applications. Results from the testing can be used by lighting engineers, sales resources, manufacturers, packaged LED suppliers, and end users to match their existing lighting to within an acceptable range of CCT. The acceptable range can vary depending on the particular project, with some embodiments of the method having an acceptable range of within +/−100K CCT. It is understood that other embodiments can have a higher range and others can have a lower range.

The methods according to the present invention can comprise many different steps that can be performed in different order. Some embodiments can comprise the same steps performed in different order, while other embodiments can comprise different steps. The following describes just some of the many light matching methods according to the present invention, and these steps can be applied in both indoor and outdoor lighting applications.

The embodiments herein are described with reference to LED based replacement light fixtures, but it is understood that the methods can be used with other solid- state emitters or other similar emitters. The LED lamps can have different components with some having different control devices that can control when the lamps emit light and to what intensity. Some of these controls can be hard wired into the LED lamps while others can comprise wireless communication devices that allow for emission of the lamps to be controlled wirelessly. In some embodiments the LED lamp emission can be controlled by cell phone. In other embodiments, the lamps can comprise sensors such as night time or motion sensors to control when the lamps emit. When a single LED lamp is described below it is understood that multiple LED lamps can be used as well.

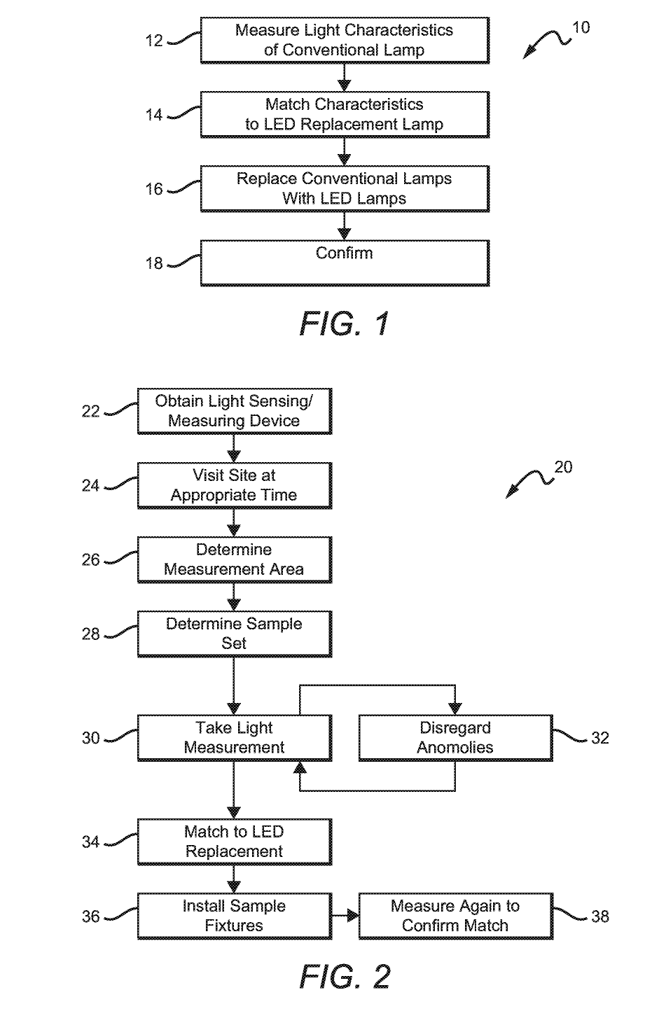

FIG. 1 shows one embodiment of light replacement method 10 according to the present invention. In the first step 12, the light characteristics of light installation using conventional light sources are measured. This can be done over a desired sample of lights over the desired measurement area (i.e. area where lights are to be replaced). The measurement area should be large enough to capture and adequate selection of existing light sources and can be determined by the size of the lighting project. The sample set of lights can as little as 3 lights and as many as 50 or more, depending on the size of the lighting project. In some embodiments the number of sample lights comprise 10-20 lights.

Different light measuring devices can be used as described below with the characteristics being saved for use in select LED based light fixtures to replace the conventional light sources. Different light characteristics can be measured such as color temperature, color rendering index, brightness, etc. The measurement of light typically takes place at each of the sample sources using essentially the same measurement procedure at each source as described below.

In the second step 14 the measured characteristics are used to select LED lamps to replace the conventional lamps. This can be done by selecting from samples of prefabricated LED lamps that emit light over the appropriate emission range of characteristics such that the measured characteristic matches or closely matches one of the sample lights. Alternatively, the characteristics can be used to fabricate custom LED lamps that emit with the desired characteristics.

In step 16, the conventional lamps can be replaced with the LED lamps using conventional procedures. In alternative step 18, the lighting area can be measured again using the measuring device in step 12 to confirm that the replacement LED lamps emit characteristics that are the same as or close to (i.e. within acceptable deviation) the measured characteristics of the conventional lamps. This ensures that the LED replacement lamps emit light with essentially the same characteristics as the conventional lamps, which will improve customer and public acceptance of the LED replacement lamps.

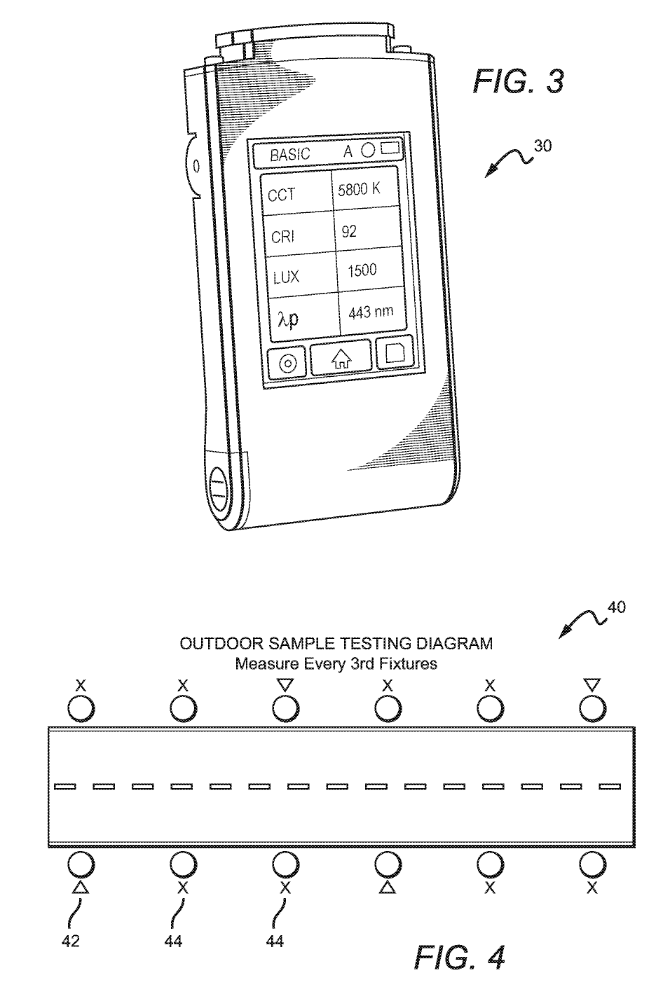

As mentioned above, the different methods according to the present invention can comprise different steps performed in different ways. FIG. 2 shows another embodiment of a light replacement method 20 according to the present invention having some steps similar to those in method 10, but also including additional steps. In the first step 22 the user obtains or is provided with a portable spectrometer or other similar light sensing or measuring device, along with precise written instructions of the proper calibration of the device, settings, data retention and exporting, and field use. Many different spectrometers can be used, including commercially available devices. FIG. 3 shows one suitable and commercially available spectrometer 30 sold as an Ikan MK350N-PLUS Spectrometer. Other acceptable measurement tools can include the commercially available Selonic C-7000/C-700U/C-700R-U, UPRTek CV600, UPRTek MK350N, and laptop/phone measurement devices such as Lumu Power iOS-based spectrometer tools.

In step 24, the engineer or field agent visits the neighborhood or area designated for light replacement with the spectrometer. This visit should take place at a time that represents the optimum time for the intended illumination by the lights in the area. For example, for a lighting area that is designed to illuminate at night the visit should take place long enough after sunset and before sunrise so that sunlight does not impact measurements. This can be different times, with one embodiment being a minimum of one hour after sunset and one hour before sunrise. It is understood that light measurements should be as close as possible to normal, or “ideal” night time conditions. This includes avoiding light generated by external events such as construction, emergency, sporting event, or other atypical activity that could affect the light color measurement.

In step 26, the appropriate measurement area is determined for achieving accurate light measurements. The measurement area refers to the general geographic area (if outdoors) or room/set or rooms (indoor environments) where the end user desires to install LED lighting products that match the color of the existing light sources. It is understood that step 26 could take place at different times such as before step 22 or 24. For example, when the lighting needs to be measured at night, it may be easier to determine the appropriate measurement area in the daytime as opposed to at night. Under these circumstances the method can comprise a pre-visit to map out the measurement area.

For larger replacement projects it may be impractical to measure all the conventional lamps. In step 28 the sample set of lamps is designated to achieve accurate light measurements. The sample set refers to the group individual light fixtures or lamps within the measurement area that will be measured under this process. Since all existing light sources are not exact color temperatures, but rather fall within a color temperature range of around 25-150 Kelvin, it is necessary to collect measurements from fixtures greater than their light “throw” or beam. In order to obtain the most accurate readings, the technician can measure in regular intervals such as by every 3^{rd} or 4^{th} fixture in the measurement area for outdoor applications. FIG. 4 shows one embodiment of street lighting lamp replacement area 40 where the sample set is taken every 3^{rd} light 42 signified by the triangles adjacent the light. The X 44 shows lights that are not part of the sample set. The goal is for the color temperature of one fixture to not affect the reading from another fixture based on proximity to the measurement device. Another goal is to reduce the burden and complexity of the measurement step by not having to measure every lamp in the measurement area. This set of measurements can be referred to by many different names, with one embodiment referring to the measurements as the “sample set—existing CCT and wavelength”.

Like step 26, step 28 can also take place prior to step 22 and 24, but typically in conjunction with step 26. When measuring in nighttime applications it may be more convenient to determine the measurement area and samples during the daytime, prior to when the actual light measurements are taken.

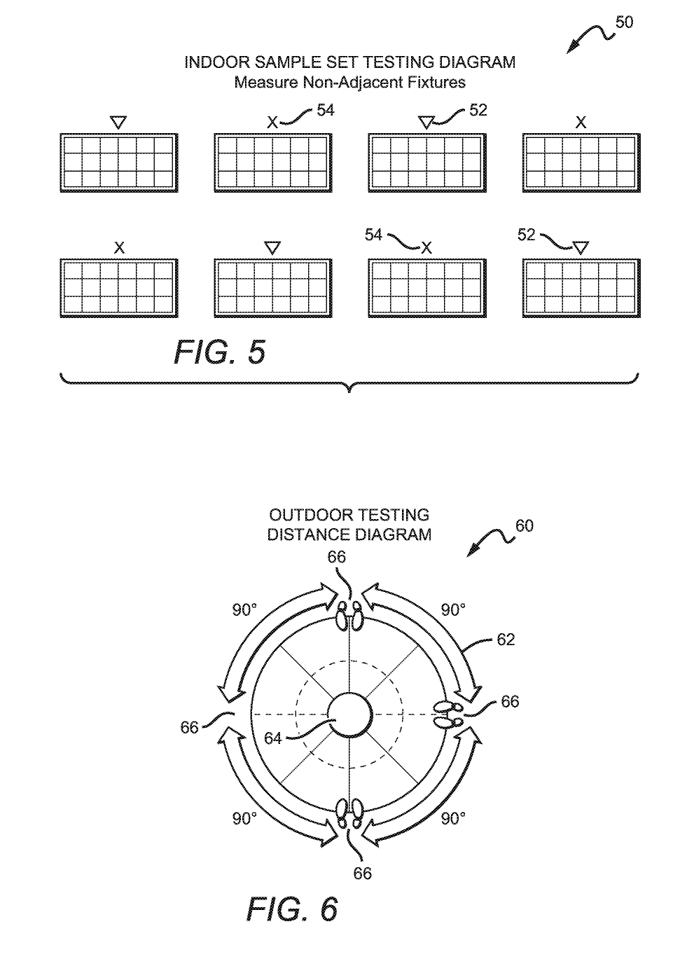

For indoor lighting replacement, the sample set can comprise every other light, every 3^{rd} light or every 4^{th} light. It is understood that in other embodiments different intervals can be used for the sample set. FIG. 5 shows one embodiment of an indoor lighting area 50 and the sample set that measures every other light signified by the triangle 52. The X 54 corresponds to lights that are not measured. Depending on requirements and existing lighting layouts, a sample set with a total of 3-100 averaged readings can be taken from the corresponding number of light fixtures.

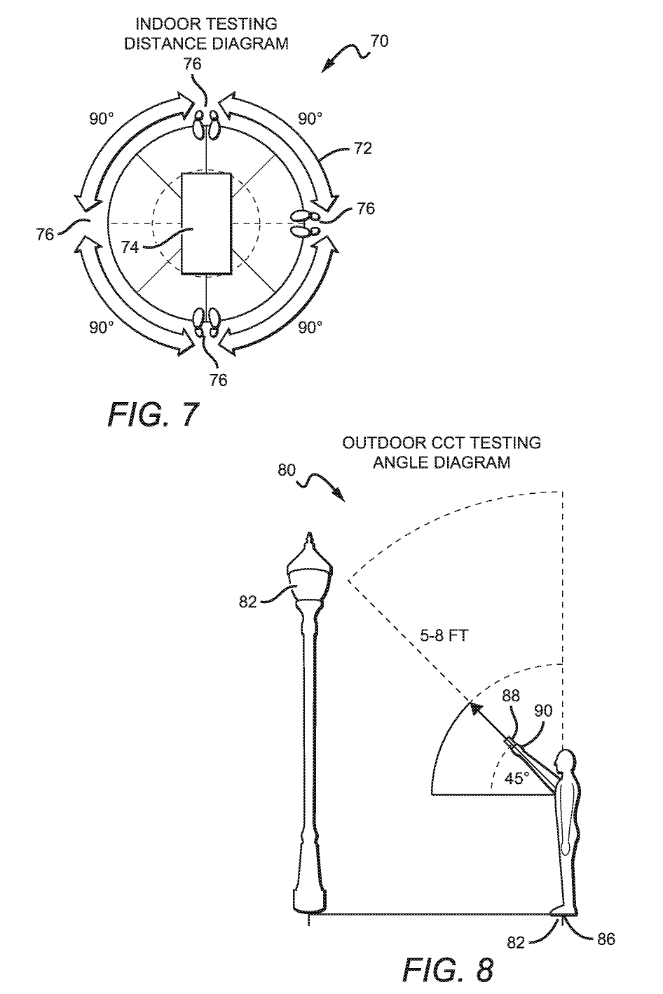

In step 30, lighting measurements are taken from each light designated in the sample set. A number of measurements are taken around each light to measure its emission profile. Different numbers of measurements can be taken, with some embodiments having three measurements per fixture. These measurements are then used to provide the sample fixture CCT. FIG. 6 show one embodiment of a measurement pattern 60 that can be used for outdoor light fixtures. The measurements can be taken in a circle 62 around the light fixture 64, with the light fixture being approximately at the center of the circle 62. The measurement points 66 can be approximately equidistant from one another around the circle 62. The circle 62 provides measuring points 66 that are approximately the same distance from the light fixture 64. Similarly, FIG. 7 shows one embodiment of a measurement pattern 70 used for measuring an indoor light fixture 74. Like the indoor light fixture, the pattern 70 comprises a measurement circle 72 with the light fixture approximately at the center of the circle. The measurement points 76 are approximately equidistance around the circle 72.

FIG. 8 shows a side view of one embodiment of a measurement position 80 for a user to take the measurement for an outdoor light fixture 84 at a measurement point 86 around a measurement circle 82 as described in FIG. 6. The measurement can be taken by the user taking the measurement device (e.g. spectrometer) 88 in his hand 90 so that the device's sensor is aimed at the light fixture 84. In the embodiment shown, the device 88 is held in the user's hand with the arm extended are at an approximate 45-degree angle to the light fixture 84 and with the sensor at a distance of approximately 5-8 feet from the light fixture for outdoor lighting. Three to four separate readings can be taken at the same distance from the light fixture 84 in a circle around the light as shown in FIG. 6.

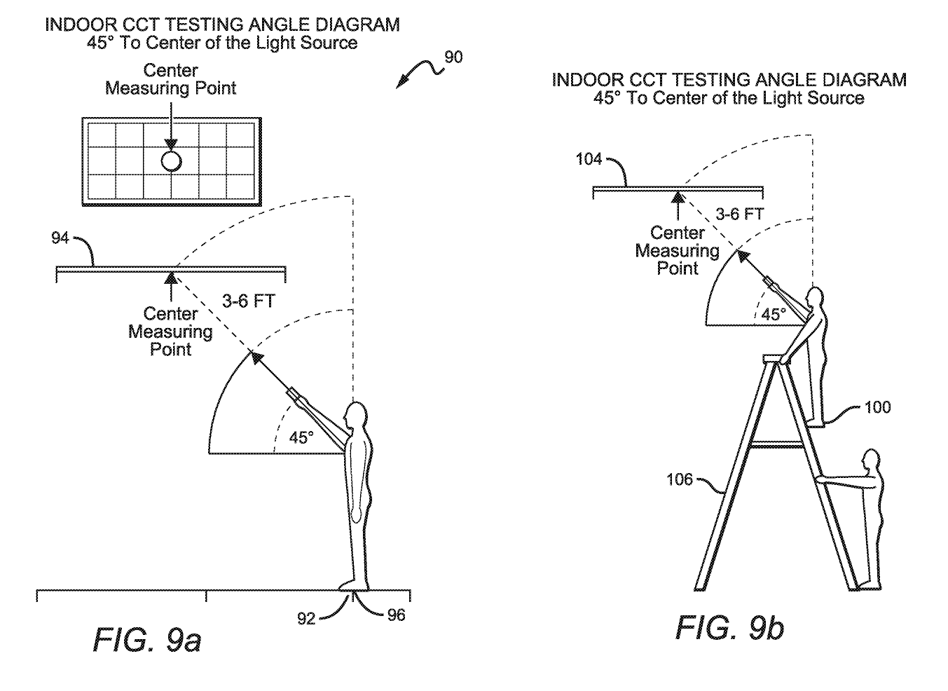

FIG. 9a shows a side view of one embodiment measurement position 90 for a user to take measurements of an indoor light fixture 94. Like above, the measurement can be taken at a measurement point 86 around a measurement circle 82 as described in FIG. 7. For indoor light fixtures, the measurement device 88 is also held in the user's extended arm at an approximate 45-degree angle, with the measurement point being 3-6 feet from the light fixture 94. Three to four separate readings can be taken at the same distance from the light fixture 94 in a circle around the light fixture. It is understood that the measurements from the user's extended arm can be different angles, but should be conducted at the same or similar angle through the project for consistency. The angle range can be 30-45 degrees for outdoor fixtures to reduce glare effects and obstructions. For indoor, the readings should also be taken at the same angles for each light fixture, or can be taken directly underneath each fixture.

FIG. 9b shows a side view of still another embodiment of a measurement position 100 for light fixture 104 that is housed in a higher location. For these embodiments, a means for elevating the user can be employed to place the user at the desired distance from the light fixture. In the embodiment shown, a ladder 106 is used for elevating the user, but in other embodiments other means can be used such as lift. The same number of equidistant measurements can be taken in circle around the light fixture 104.

A minimum of three and a maximum of 100 averaged sample fixture CCT values are averaged to provide sample set final CCT value. Color matching can require a minimum of three readings each from three different fixtures in the sample set. Larger projects or those with more complex requirements (such as matching the color of a variety of different fixtures or different optical characteristics (frosted and clear diffusers for example) will require a higher number of measurements.

Many fixtures and enclosures in municipal systems show the effects of their environment, including enclosures that are dirty, faded, yellowed, stained, or otherwise discolored. These would be considered anomalies and should not be considered when determining color matching. Referring again to FIG. 2, in step 32 any measurement from a light that is more than +/−100 CCT from overall light average can be discarded to account for any effect on the CCT measurement created by a fixture with light output that has been altered by degraded fixture materials.

In step 34, replacement LED lamps are acquired that are a match or approximate match to the measured characteristics. To ensure an exact or close match, the user can install sample lamps in a range of suggested colors, including 1800K, 2000K, 2200K, 2400K, 2600K, and 2700K (using these samples to closely match measurements). In some embodiments, LED lamps can be matched to a corresponding one of the measured characteristics. In other embodiments, the measured characteristics can be averaged and the replacement LED lamps can be matched to the average.

In step 36, all the conventional light sources at the replacement site can be replaced with the selected LED lamps using conventional lamp removal and installation methods. In step 38, after the replacement installation in the replacement site, the engineer or field agent can return to the measurement area site and take the same measurements at the sample lamps as described in the previous steps. Those measurements are then averaged, providing the “sample set—LED replacement CCT”. In this step the engineer or field agent can confirm that the replacement LED lamp emission characteristics are the same as (or are within an acceptable deviation range) as the conventional lamp emission characteristics.

This process provides efficient and accurate method of providing LED replacement lamps with a close match to CCT and color spectrum measurements of the existing fixtures, providing a seamless transition to LED and its economic and environmental benefits.

The process is designed to provide a new LED installation that matches the previously existing light sources in the following metrics: LED CCT matches previous CCT to within a deviation of +/−100K, undesirable “blue light” has been eliminated, the LED installation matches the general look and feel of the previous light sources. In other embodiments LED CCT matches to conventional lamp CCT can be within a deviation of +/−250K. In other embodiments, the deviation for the replacement sample set can be less than 20% of the CCT from the existing sample set, while in other embodiments the deviation for the replacement sample set can be less than 10 of the CCT of the existing sample set. It is understood that many other metrics can be used with the methods according to the present invention.

Although the present invention has been described in detail with reference to certain preferred configurations thereof, other versions are possible. For example, measurements of the conventional and LED lamp characteristics need not be taken by hand, but can be taken by a vehicle or drone. Therefore, the spirit and scope of the invention should not be limited to the versions described above. The foregoing is intended to cover all modifications and alternative methods falling within the spirit and scope of the invention. No portion of the disclosure is intended, expressly or implicitly, to be dedicated to the public domain if not set forth in any claims.

I claim:

1. A method for replacing conventional light fixtures with solid state light fixtures, comprising:
a first measuring of one or more light emission characteristics of sample conventional lamps within a light replacement area, wherein said sample conventional lamps comprise less than all the lamps in said light replacement are;
recording the location of said sample convention lamps and generating a first sample set of conventional light emission characteristics from said first measuring;
matching said conventional lamp emission characteristics to emission characteristics of replacement LED lamps;
replacing all of said conventional lamps in said light replacement area with said replacement LED lamps;
a second measuring of the emission characteristics of said LED replacement lamps at each of said locations of the said measured conventional lamp;
generating a second sample set of said LED replacement emission characteristics based on said second measuring; and
comparing said first sample set to said second sample set to confirm they are the same or are within an acceptable deviation.

2. The method of claim 1, wherein said deviation is +/−100K correlated color temperature (CCT).

3. The method of claim 1, wherein said deviation of said second sample set being within 10% of said first sample set.

4. The method of claim 1, wherein said light emission characteristics comprise one or more of correlated color temperature (CCT), color rendering index (CRI) and brightness.

5. The method of claim 1, the measured emission of each of said sample conventional lights is selected such that the emission of one of said samples does not affect the emission measurement from another of the said samples.

6. The method of claim 1, wherein said sample conventional lamps are at regular intervals in said light replacement area.

7. The method of claim 1, wherein said sample conventional lamps comprise every third or fourth lamp in said replacement area.

8. The method of claim 1, wherein each of said first measuring of said emission characteristics of each of said sample conventional lamps comprises taking multiple emission measurements are taken equidistance around said lamp.

9. The method of claim 8, wherein each of said multiple measurements are taken equidistance in a circle around said lamp.

10. The method of claim 8, wherein said multiple measurements comprise three or four measurements.

11. The method of claim 8, wherein said measurements are taken by a light sensor held at 30-45 degrees to said lamp and 5-8 feet from said lamp.

12. The method of claim 8, wherein said measurements are taken by a light sensor held at 30-45 degrees to said lamp and 3-6 feet from said lamp.

13. A method for replacing conventional light fixtures with solid state light fixtures, comprising:
selecting a replacement area comprising a plurality of conventional lamps;
selecting a sample of said plurality of conventional lamps in said replacement area;
measuring the emission characteristics for each of said sample plurality of conventional lamps;
matching said conventional lamp emission characteristics to emission characteristics of replacement LED lamps;
replacing all of said conventional lamps in said light replacement area with said replacement LED lamps;
measuring the emission characteristics of said LED replacement lamps at each of said locations of said sample plurality of conventional lamps; and
comparing said sample conventional lamp emission characteristics to LED replacement lamp characteristics to confirm that they are the same or are within an acceptable deviation.

14. The method of claim 12, further comprising generating a first sample set of conventional light emission characteristics from said sample plurality of conventional lamps.

15. The method of claim 12, further comprising generating a second sample set of said LED replacement emission characteristics from said LED replacement lamps.

16. A method for replacing conventional light fixtures with solid state light fixtures, comprising:
selecting a sample of conventional lamps at regular intervals within a light replacement area;
measuring one or more emission characteristics of each of said sample of conventional lamps;
selecting solid state replacement lamps that match said one or more emission characteristics;
replacing all lamps in said replacement area with said selected solid state replacement lamps;
measuring the emission characteristics of said selected solid state lamps; and
comparing said emission of said conventional lamps to said emission of said solid state lamps to confirm that the emission characteristics are the same or are within an acceptable deviation.
